(19) United States
(12) Patent Application Publication
(10) Pub. No.: US 2025/0368147 A1
(43) Pub. Date: Dec. 4, 2025

(54) PORTABLE EXERCISE RIG WITH INTEGRATED BIKE RACK

(71) Applicant: Talan A. Knox, Salt Lake City, UT (US)

(72) Inventor: Talan A. Knox, Salt Lake City, UT (US)

(21) Appl. No.: 19/215,813

(22) Filed: May 22, 2025

Related U.S. Application Data
(60) Provisional application No. 63/654,010, filed on May 30, 2024.

(51) Int. Cl. B60R 9/10; A63B 21/00; A63B 23/12; B60R 9/06

(52) U.S. Cl. CPC B60R 9/10; A63B 21/00047; A63B 23/1218; A63B 23/1227; B60R 9/06; A63B 2210/50; A63B 2225/093

(57) ABSTRACT

A combined bike rack and exercise rig may feature a pivotable and selectable combined bike rack and dip bar assembly mounted upon a support spine, which may be selectively deployed in either configuration for use. Other exercise apparatuses may be mounted to the support spine, such as a pull-up bar. The spine may also feature an attachment structure for use with a vehicle hitch and support structure for use during deployment or storage. Pivotable components may have an integrated keyway to encompass the support spine and provide a more secure stowed configuration while traveling.

### CROSS-REFERENCES TO RELATED APPLICATIONS

The present invention claims the benefit of prior filed U.S. Application No. 63/654,010, filed on May 30, 2024, and incorporates the same by reference herein in its entirety.

### FIELD OF THE INVENTION

The present invention relates to the field of exercise equipment and more particularly relates to a portable exercise rig which may double as a vehicle's bike rack.

### BACKGROUND OF THE INVENTION

The pursuit of fitness is a noble one that takes dedicated time and effort. Depending on the desired level of fitness, people may spend significant amounts of time exercising at a gymnasium or utilizing various forms of equipment to practice any number of varied exercises. Recognizing the desire for people to exercise and maintain a regimen, many companies have developed “home gymnasiums” which provide various forms of exercise equipment, such as dip bars, resistance rods or bands, pullies, pull-up bars, exercise benches, etc., in a compact, usually stowable, configuration which is suitable for most homes.

Generally speaking, pausing a fitness regimen for as little as one week can produce noticeable loss of endurance and strength. So, when an individual desires to enjoy a vacation, the availability of exercise equipment, or rather the lack of such equipment, might cause that individual either limit where a vacation may be spent or limit time away on that vacation for fear of losing the availability of the necessary equipment to continue a fitness regimen. While many hotels and resorts have fitness equipment, often said equipment is rudimentary, consisting of a treadmill and/or exercise bike, with little else, and there is no guarantee as to the equipment's state of repair. In cases when an individual wants to eschew such facilities, such as while enjoying a camping excursion, no such equipment will be extant, short of finding a gymnasium or fitness center near where the individual wants to camp. In such situations, an individual may be able to cobble together a regimen for while they are on vacation, but there is little out there to assist in the endeavor.

As taking fitness equipment to the outdoors is a generally prohibitive endeavor, some efforts have been made to create a basic but portable framework that would allow an individual to continue a basic fitness regimen while otherwise away from a usual gymnasium. In particular, hitch-mounted equipment has been developed so that the individual could take a basic home gymnasium to a remote location. These solutions can deliver an apparatus to such a location but it often must be done at the expense of something else, such as a bike, because a home gymnasium, even in a most basic and compact form, will take significant room on a vehicle and occupy a vehicle's trailer hitch.

The present invention is a portable exercise apparatus that combines a home gymnasium with a bike rack, allowing for the apparatus to accommodate two purposes as opposed to one. The exercise apparatus utilizes a combination dip bar and bike rack assembly which allows for the use of the dip bar when deployed, and then naturally presents the bike rack for use when the dip bar is rotated into a stowage position. A pull-up bar is also presented in deployed and stowage positions. Both components feature a keyway to accommodate a support spine and allow for tighter and more compact stowage. A support post may also provided for added stability when in use as an exercise rig or for storage of the rig. The present invention represents a departure from the prior art in that the combination exercise rig and bike rack of the present invention allows for compact and easy deployment and stowage by simply rotating the two main components against the support spine.

### SUMMARY OF THE INVENTION

In view of the foregoing disadvantages inherent in the known types of portable exercise rigs, an improved rig may utilize a combined pivotable dip bar and bike rack to allow for more compact stowage while allowing for easy and intuitive deployment for use.

The more important features of the invention have thus been outlined in order that the more detailed description that follows may be better understood and in order that the present contribution to the art may be better appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

In order to describe the manner in which the above-recited and other advantages and features of the invention can be obtained, a more particular description of the invention briefly described above will be rendered by reference to a specific, and non-limiting, example embodiment thereof which is illustrated in the appended drawings. Understanding that these drawings depict only one typical embodiment of the invention and is therefore not to be considered as limiting of its scope, this best mode of the invention will be described and explained with additional specificity and detail using the accompanying drawings.

FIG. 1 is a perspective view of a combination exercise rig and bike rack in accordance with one embodiment of the invention;

FIG. 2 is a side elevation of the exercise rig and bike rack of FIG. 1.

FIG. 3 is a front elevation of the exercise rig and bike rack of FIG. 1.

FIG. 4 is a perspective view of the exercise rig and bike rack of FIG. 1 in a stowed configuration.

FIG. 5 is an exploded view of the exercise rig and bike rack of FIG. 1.

FIG. 6 is a perspective view of the support spine of the exercise rig and bike rack of FIG. 1.

FIG. 7 is a perspective view of the attachment shoe utilized in the exercise rig and bike rack of FIG. 1.

FIG. 8 is a perspective view of the support post of the exercise rig and bike rack of FIG. 1.

FIG. 9 is a perspective view of the pull-up bar of the exercise rig and bike rack of FIG. 1.

FIG. 10 is a perspective view of the combined dip bar and bike mount of the exercise rig and bike rack of FIG. 1.

FIG. 11 is an alternate perspective view of the exercise rig and bike rack of FIG. 1.

FIG. 12 is a close-up view of the pull-up bar of FIG. 9, deployed.

FIG. 13 is a close-up view of the pull-up bar of FIG. 9, stowed.

FIG. 14 is a close-up view of the dip bar/bike rack assembly, deployed.

FIG. 15 is a close-up view of the dip bar/bike rack assembly, stowed.

FIG. 16 is a is a close-up view of the support assembly, deployed.

FIG. 17 is a is a close-up view of the support assembly, stowed.

### LISTING OF REFERENCE NUMERALS

The following are reference numerals used throughout the detailed description of the preferred embodiment:
100—Combination exercise rig and bike rack
110—Support Spine; (serves as spine for stowed bars)
111—Upper Attachment Boss (Pull-up Bar);
112—Upper Pivot hole;
113—Pull-up Bar Deployment Hole;
114—Pull-up Bar Stowage hole;
115—Lower Attachment Boss (Dip Bar/Bike Rack);
116—Lower Pivot Hole;
117—Dip Bar Deployment Hole;
118—Bike Rack Deployment Hole;
119—Height Selection Hole Matrix;
120—Attachment Shoe;
122—Attachment Shoe Collar;
124—Attachment Shoe Interface Holes;
126—Hitch Shank;
130—Support Post;
132—Support Post Walls;
134—Upper Adjustment Slots;
136—Lower Adjustment Slots;
138—Support Plate;
140—Pull-up bar;
142—Pull-up Bar Pivot;
144—Pull-up Bar Selector Hole;
146—Pull-up Bar Support Arm;
147—Pull-up Bar Exercise Posts;
148—Pull-up Bar Support Head;
149—Pull-up Bar Keyway;
150—Dip Bar/Bike Rack;
152—Dip Bar/Bike Rack Pivot;
154—Dip Bar/Bike Rack Selector Hole;
155—Dip Bar/Bike Rack Ears;
156—Dip Bar/Bike Rack Support Head;
157—Dip Bar/Bike Rack Keyway;
158—Dip Bar Posts;
159—Bike Rack Posts;
160—Selector Pins;
162—Attachment Bolts.

### DESCRIPTION

With reference now to the drawings, a preferred embodiment of the combination exercise rig and bike rack is herein described. It should be noted that the articles “a,” “an,” and “the,” as used in this specification, include plural referents, such as describing opposed pairs of holes as a singular “hole,” unless the content clearly dictates otherwise.

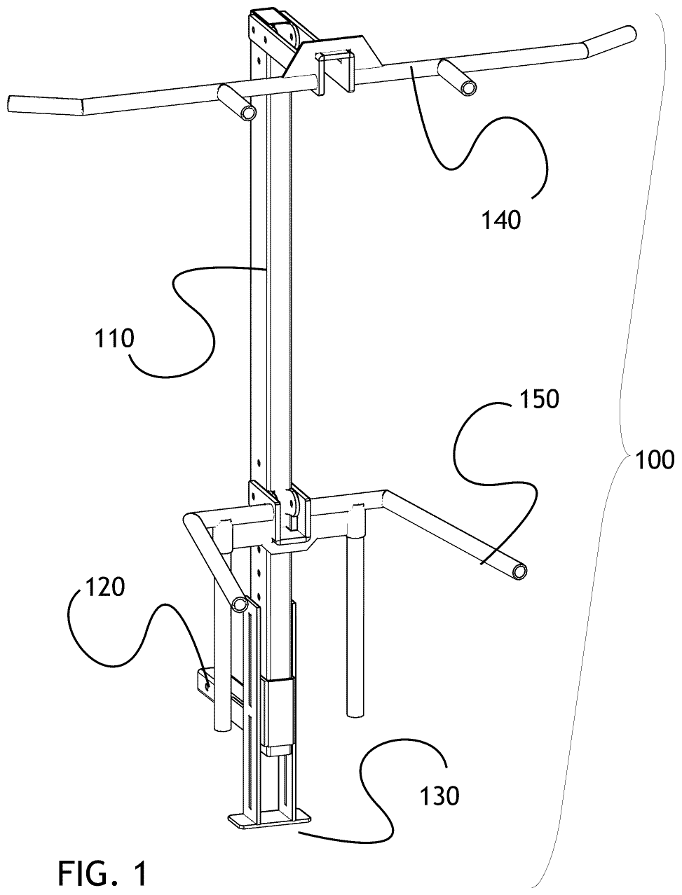

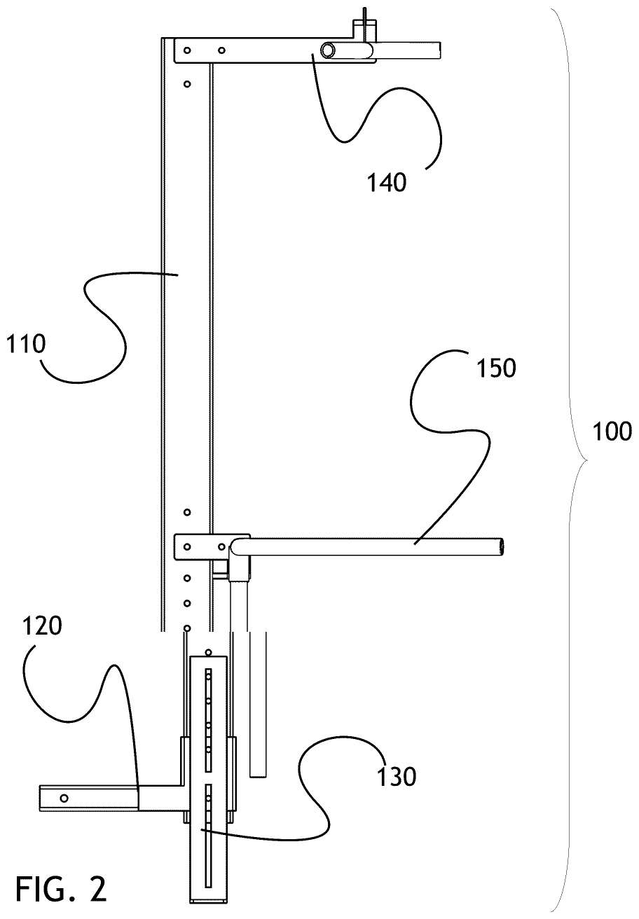

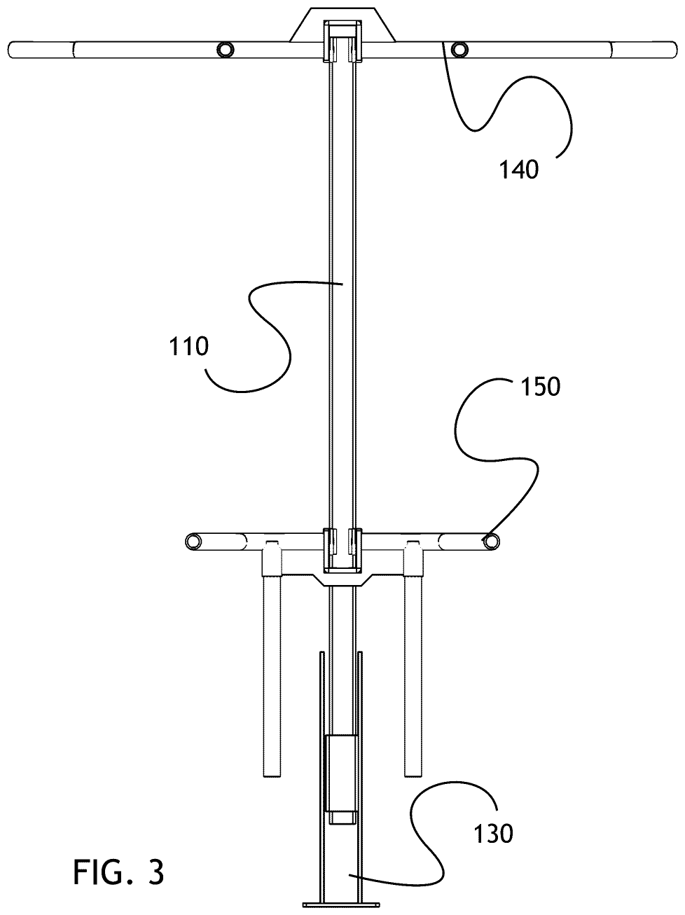

With reference to FIGS. 1-5, an exemplary exercise rig 100 may feature a support spine 110 mounted upon an attachment shoe 120, over which a support post 130 is also affixed. Various exercise devices, or apparatuses, may be attached to the support spine 100, such as the pull-up bar 140. Of central importance, though, is the combination dip bar and bike rack 150 mounted roughly in the center of the support spine 100. It should be readily understood that additional apparatuses, such as a workout bench, barre, cables for flies, and other exercise devices, may be similarly mounted upon either the support spine 100, the illustrated pull-up bar 140, or the dip bar/bike rack 150.

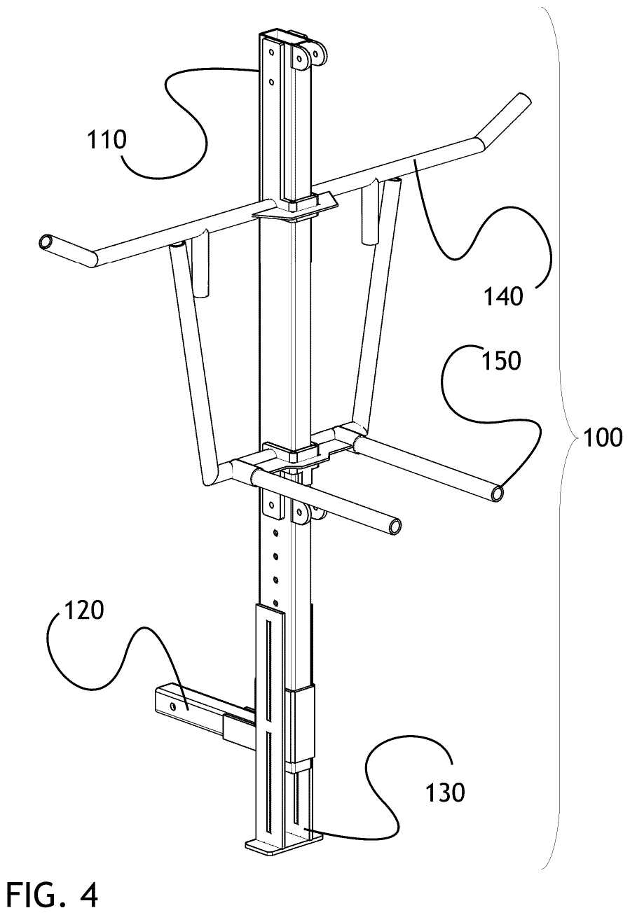

The five main components of the illustrated the exercise rig are bolted together, either in a hinged or fixed relationship. The support spine 110 is the central scaffold on which apparatuses (140, 150) are mounted, as well as support structures (120, 130) to provide stability when the exercise rig 100 is in use. A central aspect of the invention is the ability to compactly transition between the stowed and deployed configurations, as illustrated in FIGS. 1 and 4. The dip bar/bike rack 150 folds upwards when transitioning from the deployed to stowed positions, while the pull-up bar 140 folds downwards. This not only secures these two components during travel, but also presents a more compact profile, as will be described below.

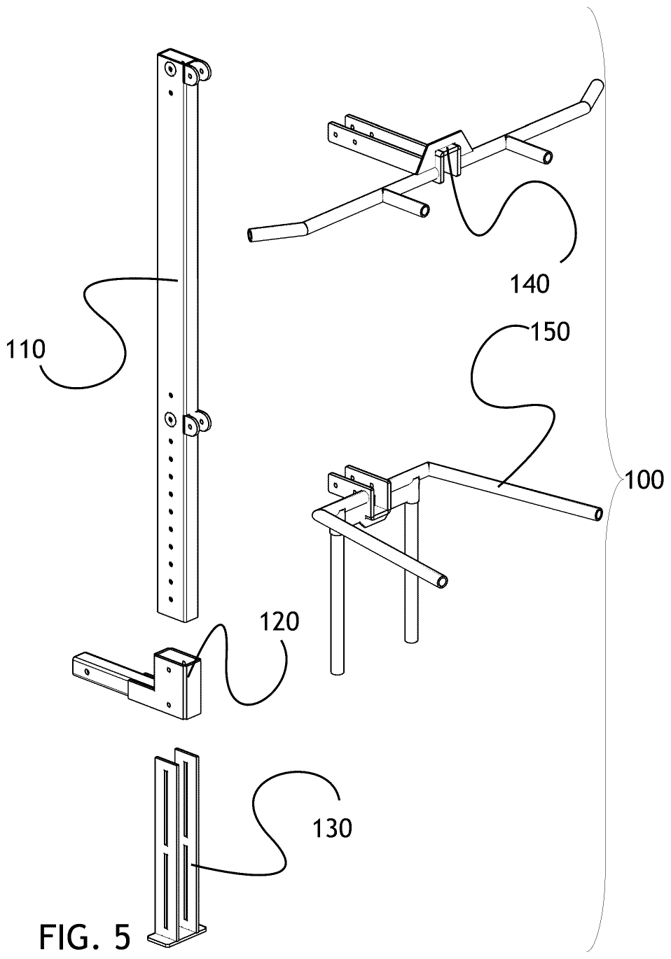

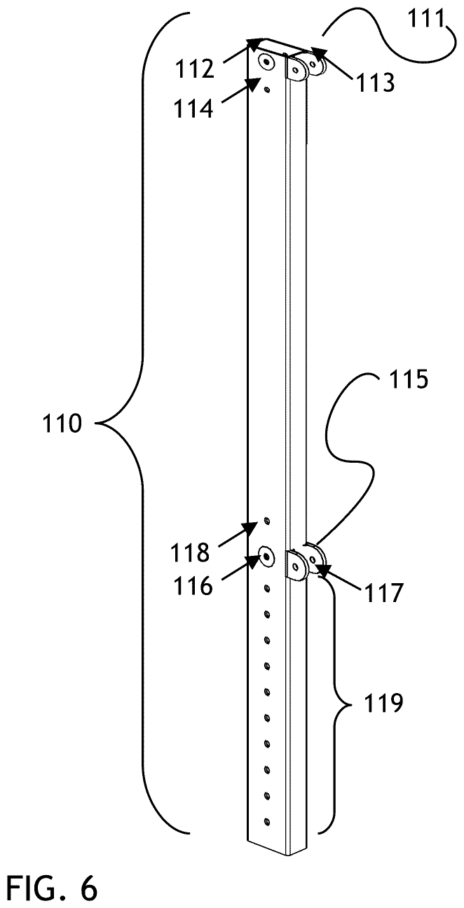

The support spine 110 (FIG. 6) may be constructed from a hollow beam of aluminum, steel, or some other suitable material. Two bosses (111, 115) project to one side of the spine 110, onto which the two illustrated apparatuses may be deployed. A series of opposed selection holes may then be bored across the beam of the spine 110 to provide selection options for the user. Towards the top of the beam, by boss 111, is an upper pivot hole 112 for mounting the pull-up bar assembly 140 (FIG. 5), as are two selection holes 113 (in the boss) and 114 (beneath the upper pivot hole 112). Lower boss 115 is located approximately in the middle of the beam and features the dip bar selection hole 117. The lower pivot hole 116 is located proximate the lower boss 115 and dip bar selection hole 117, while bike rack selection hole 118 is located above the lower pivot hole 116. Beneath the lower pivot hole may be located a matrix of height selection holes 119 extending downward therefrom. In the best mode, the holes are all in some form of orthogonal relationship with each other, with the pivot holes (112, 116), pull-up bar stowage hole 114, bike rack deployment hole 118, and the entire height selection matrix 119 residing on a single longitudinal line, ideally the centerline, of the long side of the beam of the spine 110. The pull-up bar deployment 113 and dip bar deployment holes 117 residing on the bosses, and, together with the pivot holes 112, 116, form lines perpendicular to the centerline of the beam.

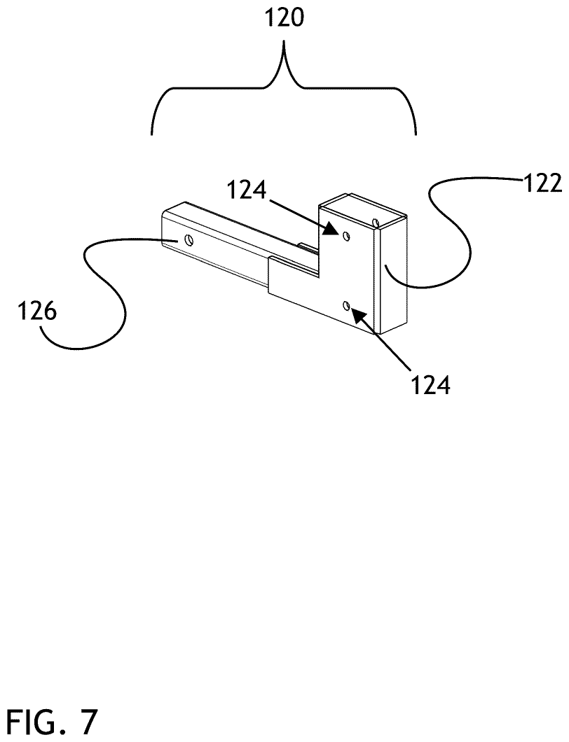

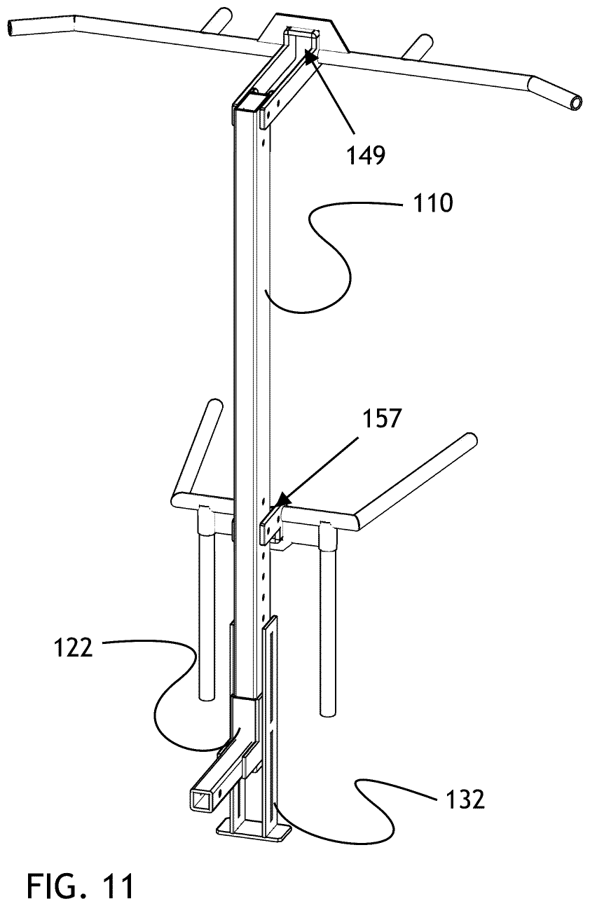

The second illustrated component is the attachment shoe 120 (FIG. 7) which mounts the support spine 110 to the support post 130 and also provides connection to the vehicle. The attachment shoe 120 is a collar 122 designed to fit around the support spine 110. Two pairs of interface holes 124 are centrally located on the collar 122. A hitch shank 126 is also provided to the collar 112, projecting rearwardly. While not shown, a hitch ball could also project from the attachment shoe 120 in an opposite direction. The support spine 110 fits within the collar 122 (FIG. 11) and is supported at a given height by selecting a pair of selection holes in the matrix 119 and bolting therethrough.

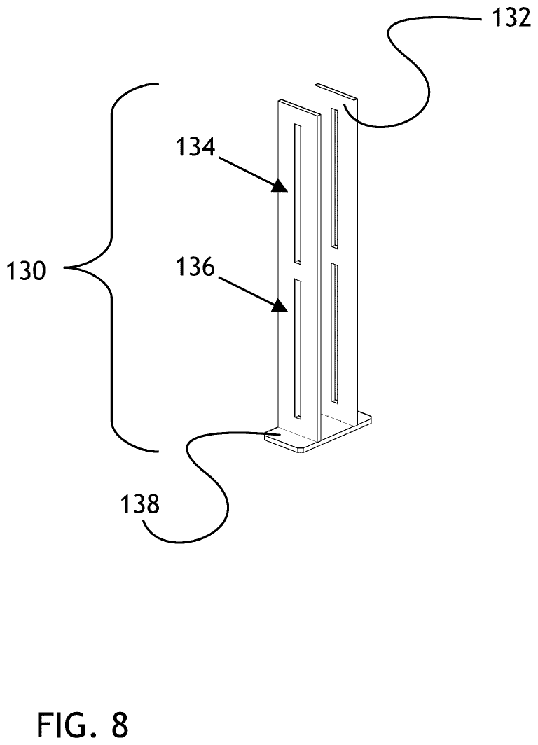

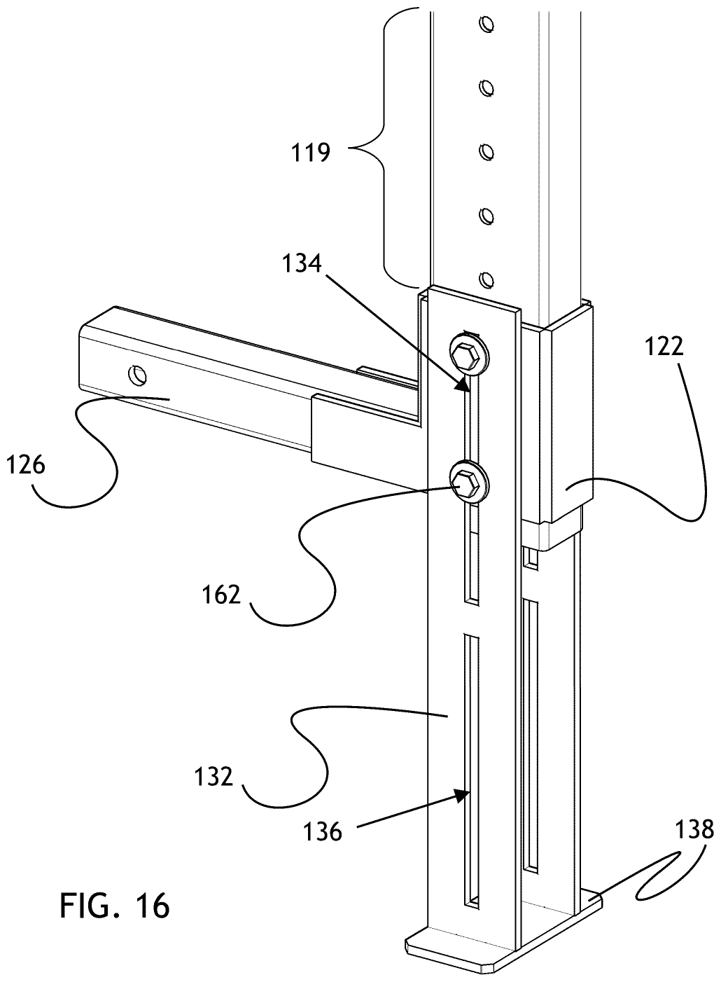

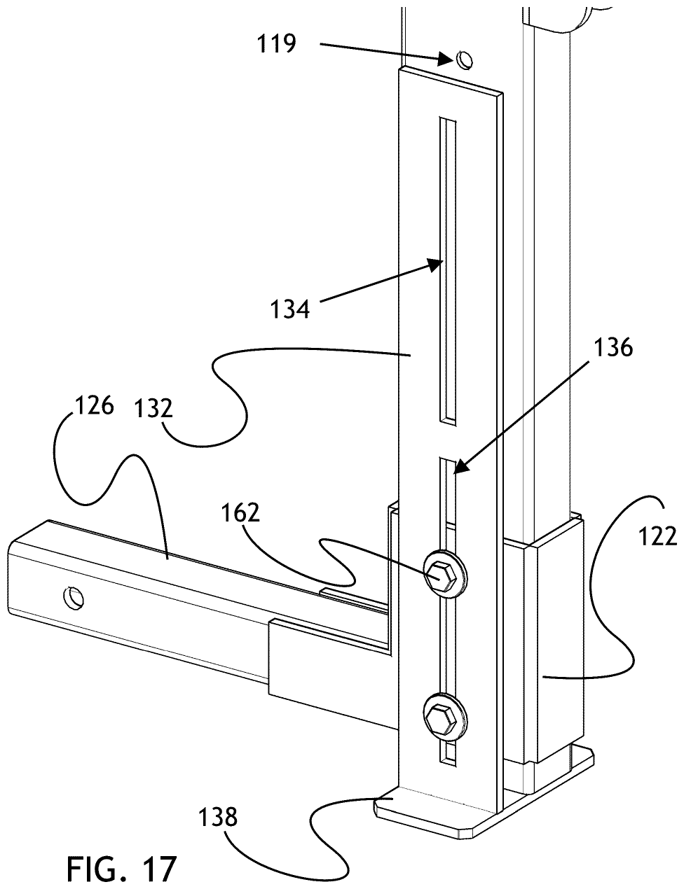

The support post 130 (FIG. 8) fits over the attachment shoe 120 (FIG. 11) along the sides of the collar 122 and support spine. The support post features two opposed walls 132 connected to a support plate 138. Two adjustment slots 134, 136 are presented upon each side 132. In use, the support post 130 may be raised or lowered relative to the attachment shoe 120 by utilizing the same bolts connecting the attachment shoe to the support spine 110. Simply loosening the bolts will allow the support post 130 to slide upwards or downwards about the attachment shoe 120 as needed. Should it be desired, bolts may be removed to allow the support post 130 to transition between attachment slots 134, 136. In this manner, the same bolts 162 used to adjust the height of the support spine 110 also adjust the height of the support post 130, simplifying deployment and maintaining a compact profile with the support spine nested within the collar 122 of the attachment shoe 120 and the sides 132 of the support post 130 sliding external of the collar 122 (FIGS. 16, 17).

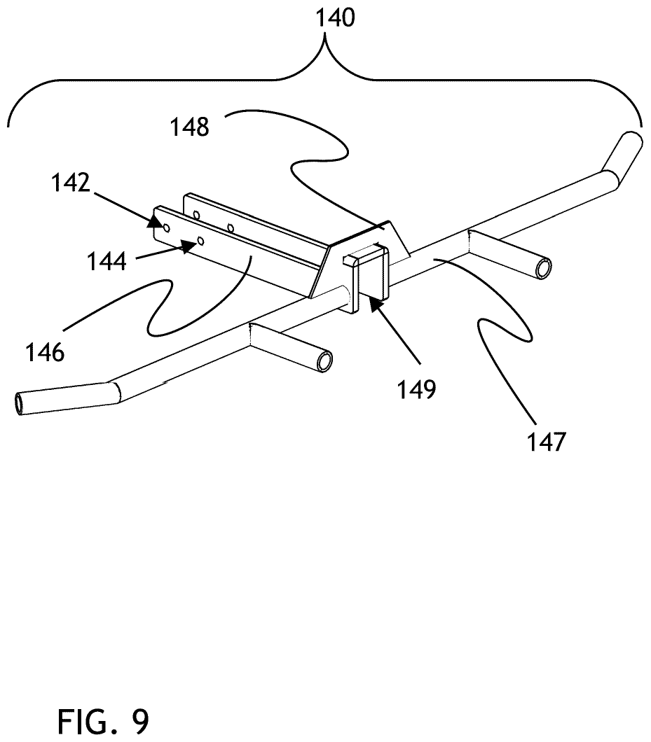

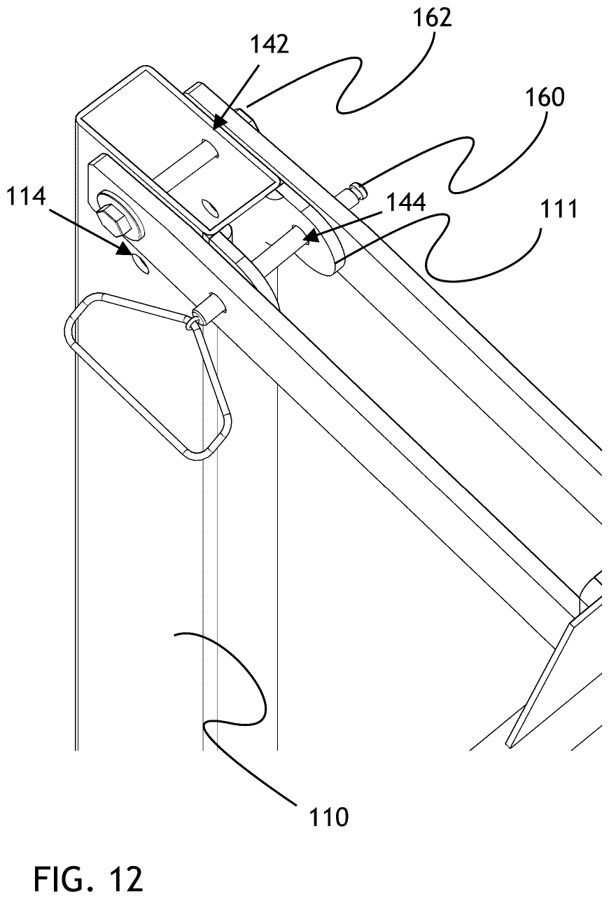

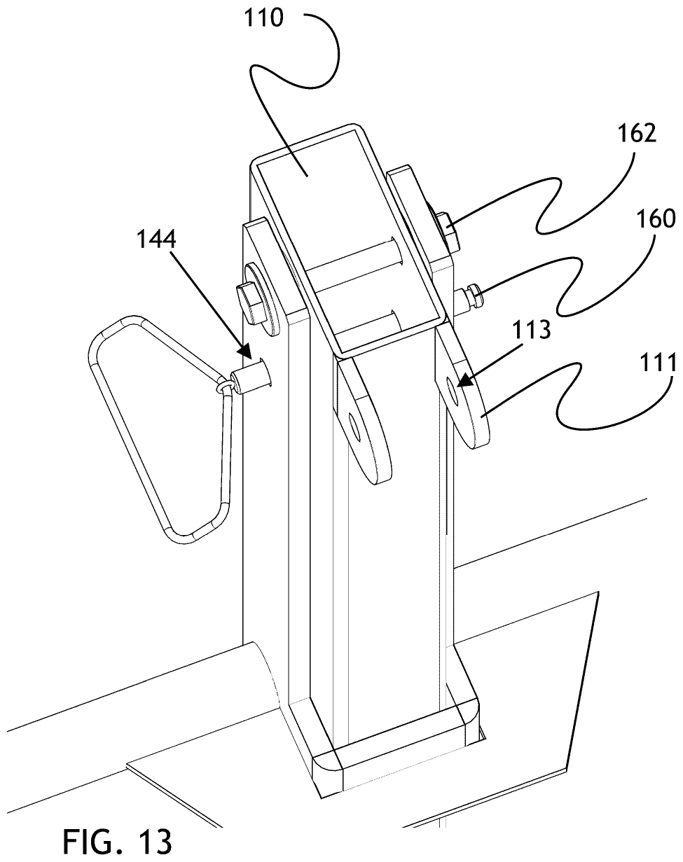

A pull-up bar 140 is a common addition to most exercise rigs 100, and this embodiment is no exception. However, the structure of the preferred pull-up bar provides a more compact profile when the pull-up bar 140 is stowed. The pull-up bar 140 (FIG. 9) features a head 148 mounted upon an attachment arm 146 designed to pivot between a cantilevered deployed configuration and a stowed position in line with the support spine 110. Exercise posts 147 extend outward of the head 148 on either side, generally perpendicular to the attachment arm 146. The far end of the attachment arm 146 is designed to interface with the pivot hole 112 of the support spine 110 (FIGS. 12, 13) using bolt 162. A selection hole 144 is positioned closer to the head 148 in a manner to interface with either the deployment hole 113 on the upper boss 111 or the stowage hole 114 on the spine 110. The bar 140 is held in whichever position by the insertion of a selector pin 160 through the selection hole 144 and whichever hole is in the appropriate chosen position, whether deployed (FIG. 12) or stowed (FIG. 13). Of note, the attachment arm 146 is ideally formed of two opposed and parallel bars of metal or suitable material while the head 148 presents a keyway 149 defining a passage with the two opposed sides. In this manner, when the pull-up bar 140 is stowed (FIG. 4), the sides of the attachment arm will surround the support spine 110 while the keyway 149 of the attachment head 148 will likewise surround the support spine 110 as a spline which will, when secured by the selector pin 162, prevent the pull-up bar 110 from flying outwards or sideways while moving on the back of a vehicle. The arrangement will then not only be compact, but also secure.

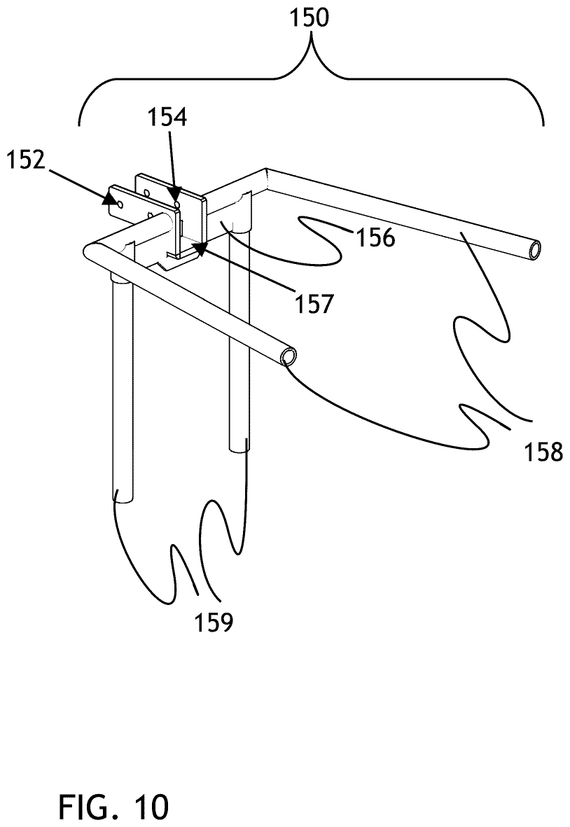

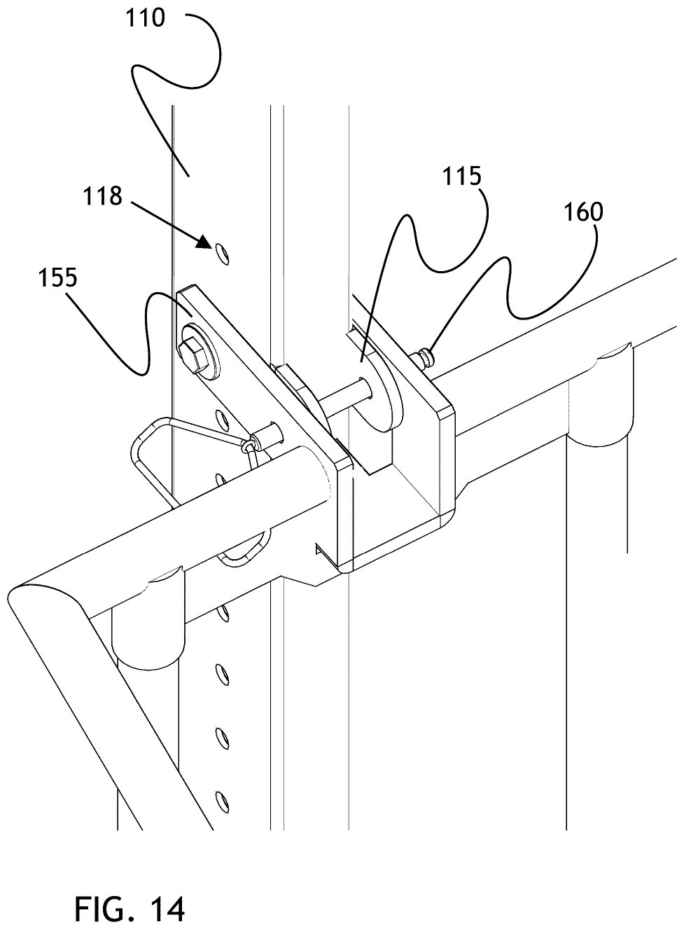

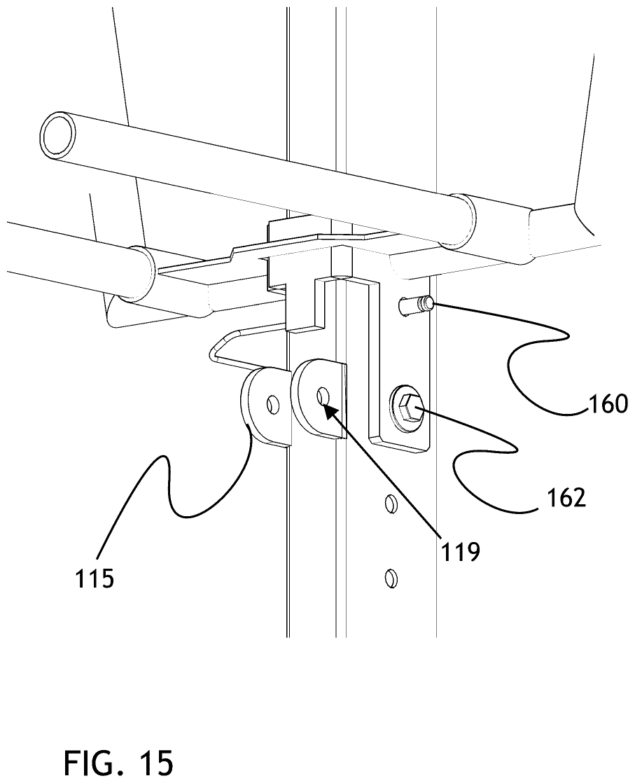

The combination dip bar and bike rack 150 (FIGS. 10, 14 and 15) is similarly constructed with a head 156 presenting its own keyway 157 and opposed ears 155 to fit about the support spine 110. However, in one configuration, opposed dip bar posts 158 are presented while in the other bike rack posts 159 are presented. The posts define one plane while the bars define another and these planes are generally orthogonal to each other, with the dip bar posts 158 slightly flared outwards from the center of the support spine 110. The flaring dip bars 158, as opposed to the straighter bike rack posts 159, present a more ergonomic dip apparatus than would the bike rack posts 159. The combined dip bar and bike rack 150 pivots about a connection bolt 162 located coaxially within the lower pivot hole 116 of the spine 110 and the pivot hole 152 of the combined apparatus. A selector hole 154 is positioned on the ears 155 between the head 156 and pivot hole 152 to accommodate a selector pin 160 inserted therethrough coaxially with the dip bar deployment hole 117 (on lower boss 115) or the bike rack deployment hole 118 (above the lower pivot hole 116 on the support spine 110). As with the pull-up bar 140, when in the “stowed” or bike rack mode (FIG. 15), the head 156 and ears 155 will define a passage through which the support spine 110 will pass and have a keyed interface therewith, restraining unwanted movement while moving the rig from place to place.

It should be readily understood that while the preferred embodiment of this apparatus is illustrated with the bike rack being deployed when the apparatus is rotated upwards, the entire apparatus may be designed for a downwards pivot to deploy the bike rack. Since one of the key features of the invention is that the apparatuses are naturally secure when traveling, it is preferred that the keyways 149, 157 defined by either the pull-up bar 140 or dip bar/bike rack 150 be surrounding the support spine 110 when in the stowed, or traveling, position in whatever orientation of the dip bar/bike rack components is desired. Structurally the invention could be practiced in the deployed, non-traveling, position but this would not be as preferred as other means of securing the apparatuses while traveling would be advisable.

It should also be understood that other apparatuses may be added to the basic framework described in the preferred embodiment. These apparatuses may be mounted upon the support spine, be integral with the support spine, or be mounted upon the described or other apparatuses. These additional apparatuses could include, without limitation, a workout bench, pullies, resistance bands or weights, punching bags and/or mounts therefor, or any other exercise apparatus deemed desirable. The inclusion of such apparatuses should be understood to still be encompassed by the basic tenants of this invention.

Although the present invention has been described with reference to preferred embodiments, numerous modifications and variations can be made and still the result will come within the scope of the invention. The described embodiments are to be considered in all respects only as illustrative and not restrictive. No limitation with respect to the specific embodiments disclosed herein is intended or should be inferred. Therefore, the scope of the invention is indicated by the appended claims rather than by the foregoing description. All changes which come within the meaning and range of equivalency of the claims are to be embraced within their scope.

What is claimed is:

1. A combination bike rack and exercise rig comprising:
a support spine attachable to a vehicle;
a combined bike rack and dip bar structure; the structure further comprising;
a pair of opposed bike rack posts, defining a post plane;
a pair of opposed dip bars defining a bar plane that is orthogonal to the post plane;
a pivot such that the bike rack posts and the dip bars are alternately selectable to be cantileverally extended from the support spine at any one time.

2. The combination bike rack and exercise rig of claim 1, the combined bike rack and dip bar structure further comprising a key way that interfaces with the spine when in a stowed configuration.

3. The combination bike rack and exercise rig of claim 1, further comprising a pull-up bar assembly pivotably mounted to the support spine above the combined bike rack and dip bar structure.

4. The combination bike rack and exercise rig of claim 3, the combined bike rack and dip bar structure and pull-up bar assembly both further comprising a key way that interfaces with the spine when in a stowed configuration.

5. The combination bike rack and exercise rig of claim 1, further comprising an attachment shoe which further comprises a support collar, through which the support spine passes, and a hitch shank extending therefrom.

6. The combination bike rack and exercise rig of claim 5, further comprising a support foot which further comprises two opposed support walls connected at a distal support plate, the support walls defining adjustment slots through which the support foot may be attached to an exterior of the support collar and support spine.

7. The combination bike rack and exercise rig of claim 6, the combined bike rack and dip bar structure further comprising a key way that interfaces with the spine when in a stowed configuration.

8. The combination bike rack and exercise rig of claim 6, further comprising a pull-up bar assembly pivotably mounted to the support spine above the combined bike rack and dip bar structure.

9. The combination bike rack and exercise rig of claim 8, the combined bike rack and dip bar structure and pull-up bar assembly both further comprising a key way that interfaces with the spine when in a stowed configuration.
